(19) United States
(12) Patent Application Publication
(10) Pub. No.: US 2026/0267899 A1
(43) Pub. Date: Sep. 10, 2026

(54) METHOD FOR NARRATIVE TEXT SUMMARIZATION AND SYSTEM THEREFOR

(71) Applicant: CJ OliveNetworks Co., Ltd., Seoul (KR)

(72) Inventors: Hyun Tak KIM, Seoul (KR); Se Un Park, Seoul (KR); Byung Hak Kim, Seoul (KR)

(21) Appl. No.: 19/556,103

(22) Filed: Mar. 4, 2026

Related U.S. Application Data
(60) Provisional application No. 63/766,389, filed on Mar. 4, 2025.

(51) Int. Cl. G06F 16/34

(52) U.S. Cl. CPC G06F 16/345

(57) ABSTRACT

The present invention relates to a narrative text summarization method using a large language model, and provides a technique that can minimize loss of context and precisely control the summary length while maintaining the narrative structure of long narrative texts.

### TECHNICAL FIELD

The present invention relates to the field of natural language processing technology, and more specifically, to a narrative text summarization method for summarizing a long narrative text using a Large Language Model (LLM). In addition, the present invention relates to a technique of performing scene-based semantic chunking, hierarchical summarization, and sentence-level compression by processing a text of a narrative structure containing a mixture of dialogues and descriptions, such as a novel, a movie script, a drama script, or the like.

### BACKGROUND ART

With the advancement in natural language processing technology, automatic summarization techniques using a large language model are actively studied recently. Particularly, in the field of document summarization, such as news articles, reports, academic papers, and the like, performance of a predetermined level or higher is shown as techniques of extractive summarization and generative summarization are applied.

However, unlike general documents, narrative texts, such as novels, movie scripts, drama scripts, and the like, include complex plot structures, interactions between characters, transition of time and space, and mixed structures of dialogues and descriptions, and therefore, it is difficult to apply existing summarization techniques as they are.

In particular, since a long narrative text often has a length of tens of thousands of tokens or more, summarization models of a one-pass algorithm have a problem of omitting some contents due to the input length limit or losing context information in the segmenting process. In addition, as dialogue-based script formats have a multi-speaker structure and include implicit meanings and emotional expressions, when they are summarized directly, there are limitations in that narrative cohesion is lowered, or consistency of character relationship is undermined.

Although hierarchical summarization methods that segment a document into predetermined units and summarize the document or methods that select and summarize important scenes are proposed to compensate for this problem, these methods are likely to omit key events or relationships between characters, and have difficulties in precisely controlling the length of summary. In addition, methods that perform additional training or fine-tuning to improve performance of the model have a burden of demanding large-scale data and operation resources.

Accordingly, there is a need for a new summarization method that can secure context preservation, length control, and consistency while reflecting the structural characteristics of long narrative texts.

### PRIOR ART DOCUMENTS

### Patent Documents

(Registered Patent 1) Korean Patent Registration No. 10-2755351 (Jan. 10, 2025)

### DISCLOSURE OF INVENTION

### Technical Problem

Therefore, the present invention has been made in view of the above problems, and it is an object of the present invention to provide a narrative text summarization method that can minimize loss of context while maintaining the narrative structure when summarizing a long narrative text.

In addition, another object of the present invention is to provide a summarization method that improves narrative cohesion in the summarization process by converting a narrative text containing a mixture of dialogues and descriptions into third-person descriptive sentences, while preserving the multi-speaker structure and implicit meaning.

In addition, another object of the present invention is to provide a method capable of improving the efficiency of processing a long input text through scene-based semantic chunking and a hierarchical summarization structure, and performing summarization in steps while maintaining the relationships between important events and characters.

In addition, another object of the present invention is to provide a summarization method that can minimize loss of key information, while precisely controlling the length of summary, through an iterative compression structure.

In addition, another object of the present invention is to provide a scalable summarization method that can perform the above functions using a plurality of large language models without additional training or fine-tuning of model parameters.

### Technical Solution

To accomplish the above objects, according to one aspect of the present invention, there is provided a narrative text summarization method comprising the steps of: (a) segmenting a narrative input text containing dialogues and descriptions into a plurality of scene-based semantic chunks; (b) generating a plurality of preprocessed texts by converting the dialogue contained in each of the semantic chunks into third-person descriptive sentences using a first large language model; (c) generating a preprocessed whole text by connecting the plurality of preprocessed texts; (d) subdividing the preprocessed whole text into a plurality of scene-based semantic chunks; (e) generating a plurality of summarized texts by summarizing each of the subdivided semantic chunks using a second large language model; (f) generating a summarized whole text by connecting the plurality of summarized texts; (g) segmenting the summarized whole text into a plurality of sentence chunks; (h) generating a plurality of compressed texts by compressing each of the sentence chunks using a third large language model; and (i) generating a compressed whole text by connecting the plurality of compressed texts.

In addition, the method may further comprise the step of (j) regenerating the compressed whole text by repeatedly performing steps (g) to (i), when a length of the compressed whole text exceeds a preset token length.

In addition, in the method, the repeated performance of step (j) may be limited within a preset number of times.

In addition, in the method, the scene-based semantic chunks may be set to include a preset number of scenes.

In addition, in the method, the preset number may be dynamically calculated according to the total number of tokens or scenes of the narrative input text.

In addition, in the method, the scene may be distinguished by at least one among a time change marker, a location change marker, an event transition marker, and a scene transition marker included in the narrative input text.

In addition, in the method, step (b) may further include the step of (b-1) providing the dialogue and an output instruction configured to convert the dialogue into third-person descriptive sentences to the first large language model.

In addition, in the method, step (e) may further include the step of (e-1) providing the subdivided semantic chunks and an output instruction configured to summarize the subdivided semantic chunks to the second large language model.

In addition, in the method, step (h) may further include the step of (h-1) providing the sentence chunks and an output instruction configured to compress the sentence chunks to a third large language model.

In addition, in the method, the output instruction may be configured to request generation of a text containing at least one among a key event, an interaction between characters, and a theme of a narrative.

In addition, in the method, the output instruction may be configured to request generation of a text that satisfies a preset token length.

In addition, in the method, the output instruction may include an example pair of text corresponding to input and output.

In addition, in the method, the output instruction may be generated by providing at least one among the dialogue, the subdivided semantic chunks, and the sentence chunks to at least one among the first large language model, the second large language model, and the third large language model.

In addition, in the method, the first large language model, the second large language model, and the third large language model may share the same model or may be configured as models different from each other.

In addition, in the method, the first large language model, the second large language model, and the third large language model may be configured without additional training or fine-tuning of model parameters.

According to another aspect of the present invention, there is provided a narrative text summarization system comprising a central processing unit and a memory, wherein the central processing unit executes instructions for performing a narrative text summarization method stored in the memory, and the method includes the steps of: (a) segmenting a narrative input text containing dialogues and descriptions into a plurality of scene-based semantic chunks; (b) generating a plurality of preprocessed texts by converting the dialogue contained in each of the semantic chunks into third-person descriptive sentences using a first large language model; (c) generating a preprocessed whole text by connecting the plurality of preprocessed texts; (d) subdividing the preprocessed whole text into a plurality of scene-based semantic chunks; (e) generating a plurality of summarized texts by summarizing each of the subdivided semantic chunks using a second large language model; (f) generating a summarized whole text by connecting the plurality of summarized texts; (g) segmenting the summarized whole text into a plurality of sentence chunks; (h) generating a plurality of compressed texts by compressing each of the sentence chunks using a third large language model; and (i) generating a compressed whole text by connecting the plurality of compressed texts.

In addition, in the system, the central processing unit may be configured to regenerate the compressed whole text by repeatedly performing steps (g) to (i), when a length of the compressed whole text exceeds a preset token length.

In addition, in the system, the repeated performance may be configured to be limited within a preset number of times.

In addition, in the system, the central processing unit may be configured so that the scene-based semantic chunks are set to include a preset number of scenes.

In addition, in the system, the first large language model, the second large language model, and the third large language model may share the same model or may be configured as models different from each other.

### ADVANTAGEOUS EFFECTS

According to the narrative text summarization method of the present invention, there is an effect of minimizing loss of context while maintaining the narrative structure in summarizing a long narrative text.

In addition, as a preprocessing step of converting dialogue into third-person descriptive sentences is included, there is an effect of reducing semantic distortion that may occur in multi-speaker structures, and improving narrative cohesion and readability.

In addition, as scene-based semantic chunking and a hierarchical summarization structure are applied, input text of a long sentence may be processed efficiently, and character relationships and key event flow may be maintained more stably.

In addition, as the length of summary can be controlled in steps through an iterative compression step, a summarization result meeting a target volume can be generated, and there is an effect of securing balance between preservation of key information and compression efficiency.

In addition, as the present invention may configure and apply a plurality of large language models identically or differently and can be implemented without additional training or fine-tuning, there is an effect of providing scalability that can be flexibly applied in various model environments.

### BRIEF DESCRIPTION OF THE DRAWINGS

FIG. 1 is a view schematically showing the overall flow of a narrative text summarization method according to an embodiment of the present invention.

FIG. 2 is a flowchart illustrating the overall sequence of a narrative text summarization method according to an embodiment of the present invention.

FIG. 3 is a flowchart schematically illustrating the iterative execution sequence of a compression process according to an embodiment of the present invention.

FIG. 4 is a view schematically showing the semantic chunking process according to an embodiment of the present invention.

FIG. 5 is a view schematically showing the flow of preprocessing semantic chunks according to an embodiment of the present invention.

FIG. 6 is a view schematically showing the flow of summarizing subdivided semantic chunks according to an embodiment of the present invention.

FIG. 7 is a view schematically showing the flow of generating a compressed text according to an embodiment of the present invention.

FIG. 8 is a view schematically showing the flow of generating an output instruction strategy according to an embodiment of the present invention.

### BEST MODE FOR CARRYING OUT THE INVENTION

Hereinafter, embodiments of the present invention will be described in detail with reference to the drawings. In assigning reference numerals to the components of each drawing, the same reference numerals will be given to the same components whenever possible although they are shown in different drawings. In addition, in describing these embodiments, when it is determined that a detailed description of related known components or functions may obscure the gist of the present invention, the detailed description will be omitted.

Terms such as “comprising”, “having”, and “configured of” used in this specification do not exclude addition of other components unless specified otherwise. In addition, even when a component is expressed in a singular form, it may be interpreted as including plural forms unless mentioned otherwise.

In describing the components of the present invention, terms such as “first”, “second”, and the like are used to distinguish one component from the other components and do not limit the order, number, or importance of the components.

When two or more components are described using terms such as “connect” , “couple”, “combine”, or the like in describing the positional relationship of the components, they may be directly connected or connected with intervention of other components therebetween. In this case, inclusion of intermediate components should be interpreted as falling within the scope of the present invention.

Although terms such as “after”, “successively”, or “next” are used in describing the temporal flow of an operation method or a production method, a non-continuous flow may also be included unless “immediately” or “directly” is specified.

In addition, the function blocks shown in the drawings are only examples of possible implementations, and various modifications are possible without departing from the spirit and scope of the present invention. The function blocks may be implemented in hardware, software, or a combination thereof, and the present invention is not limited to specific configurations.

The purposes and technical configurations of the present invention and the operational effects according thereto will be more clearly understood through the accompanying drawings, and hereinafter, embodiments of the present invention will be described in detail. The embodiments disclosed in this specification should not be interpreted as limiting the scope of the present invention, and it should be understood that various applications and modifications are possible.

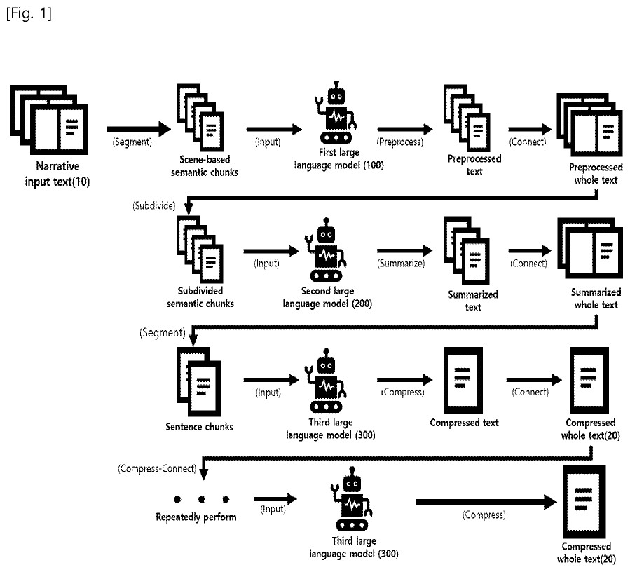

FIG. 1 schematically shows the overall flow of sequentially performing the preprocessing, summarization, and compression processes on a narrative input text 10 to generate a final summary 20.

In the drawing, a plurality of document icons arranged at the left top indicate a state of providing a narrative input text 10, which is long and contains a mixture of dialogues and descriptions, such as a novel, a movie script, a drama script, or the like. When it is attempted to summarize the input text as is, as the dialogues are segmented in the form of multiple speakers, the cause-and-effect relationship of events is disrupted or the character relationship is unclear, and cohesion of the summarization result may be lowered due to frequent transition of scenes and shift of topics. Therefore, the present invention is configured focusing on the flow of segmenting an input into small units, and processing and combining the small units again, rather than processing the input as is at once.

At the top of the drawing, the shape showing the input document converted into several document piles means a process of segmenting an input text at the scene or semantic chunk level, and at this point, boundaries of scenes may be determined by utilizing narrative clues such as time change markers, location change markers, event transition markers, and scene transition markers. For example, expressions such as “the next morning”, “when arriving at the classroom of school”, and “after the examination” may be used as representative clues for forming scene boundaries, and in the case of a script format, narrative elements such as scene prefaces, spatial notations, and entry/exit of characters may also be utilized as boundary clues.

The segmentation is not merely a mechanical segmentation for reducing the length, but it is configured to maintain the meaning at the scene level to preserve the event flow and interactions between characters in subsequent steps.

In addition, at the top of the drawing, it is shown that a preprocessing step is performed. In the preprocessing step, the portions expressed as dialogue in the input text are converted into third-person descriptive sentences, and dialogues and descriptions are normalized to a single unified narrative prose structure.

At this point, the conversion may be performed not in a method of leaving speaker markers and dialogue scripts as they are, but in a method of rewriting speech behaviors, such as who said what, agreed, suggested, or accepted, into sentences by connecting the behaviors with predicate verbs. For example, when a dialogue such as “Minsu: This problem is really hard. Younghee: Right, I also feel it's too hard. Minsu: Shall we solve it together? Younghee: Sure!” is input, the dialogue may be converted into descriptive sentences such as “Minsu said that the problem is very difficult. Younghee also agreed that she feels it is difficult. Minsu suggested solving it together, and Younghee accepted” in the preprocessed narrative text.

In this process, as the expression of grammatical person, directives, exclamations, and colloquial ending expression are organized in an extent that does not disrupt the context, the events and relationships may be traced more stably thereafter in the summarization step. In addition, when the script includes stage directions or background descriptions, they may be naturally combined with the dialogues and integrated into a narrative so that the background of events, the states of characters, and spatial arrangement may be maintained.

The unit of processing is organized as the preprocessed narrative texts are grouped into scene-based semantic chunks again, and this is intended to reduce information loss generated due to disruption of context, while utilizing the input of a long sentence as much as possible.

Subsequently, the section immediately below shows the process of performing the summarization step. Summaries of the preprocessed narrative text are generated as partial units according to previously determined semantic chunks, and the partially generated summaries are combined to form an initial summary. Here, the partial summaries are guided to be described focusing on the core of events, changes in the personalities and relationships of characters, development of conflicts, and turning points, rather than simply excerption. Since topic sentences or conclusions do not explicitly exist in the narrative text in many case unlike general documents, it is desirable to configure the summarization step to reflect the goals and behaviors of characters, results of events, and a connection link to the next scene.

At this point, it is advantageous to sufficiently and comprehensively generate the summarization result within a range that does not miss the event flow, rather than determining the length excessively short, so that additional length control may be performed in the compression step thereafter.

The bottom area of the drawing shows the compression step of refining the initial summary into a final summary that is shorter and closer to the target length. The compression step begins by subdividing the initial summary at the sentence level. Since the compression ratio may change coarsely or connection of sentences may become unnatural when length of the narrative summary is controlled only at the scene level, the compression processing may be performed basically at the sentence level in the compression step.

The compression process receives a previous summary as an input, removes duplicate expressions, integrates descriptions of equal or similar events, and rewrites them into more concise expressions while maintaining character relationships and cause and effect of the events. For example, when a sentence chunk such as “Minsu said that the problem is very difficult. Younghee also agreed that she feels it is difficult. Minsu suggested solving it together, and Younghee accepted” is input in the previous example, the compression result may be integrated into a shorter sentence while maintaining the core meaning such as “The two agree on the difficulty of the problem and solve the problem together”. The iterative indication at the bottom of the drawing means that the compression process does not finish as a single step, and the same compression method may be iteratively performed as needed.

Whether or not to repeat compression may be determined according to the length of summary desired by the user, the target length set by the system, or the length and content density of the summary, and when the target is reached, the compression is not performed any more, and the previous result may be determined as the final output 20. This iterative compression does not simply reduce the number of characters, but may be configured to balance preservation of content and control of the length by adjusting the summary to leave only the essentials when the summary is too verbose or selecting the summary of the previous step when there is a risk of disconnecting the connection between the events due to excessive compression.

A first large language model 100, a second large language model 200, and a third large language model 300 shown in the drawing are not limited to a method of learning or separately fine-tuning new model parameters, but may be implemented in a form that sequentially refines processing results by providing an output instruction tailored to the purpose of each step. The overall model may be configured to enhance cohesion through description and narrative normalization of dialogue in the preprocessing step, preserve scene-level key events and interactions between characters in the summarization step, and provide a final summary matching the target length through sentence-level iterative refinement in the compression step.

With the configuration like this, a summary that maintains the event flow and character relationships may be generated even when a long narrative text contains a lot of dialogues or frequent change of scenes, and it is possible to more stably respond to various length requirements by controlling the length of the final summary step by step.

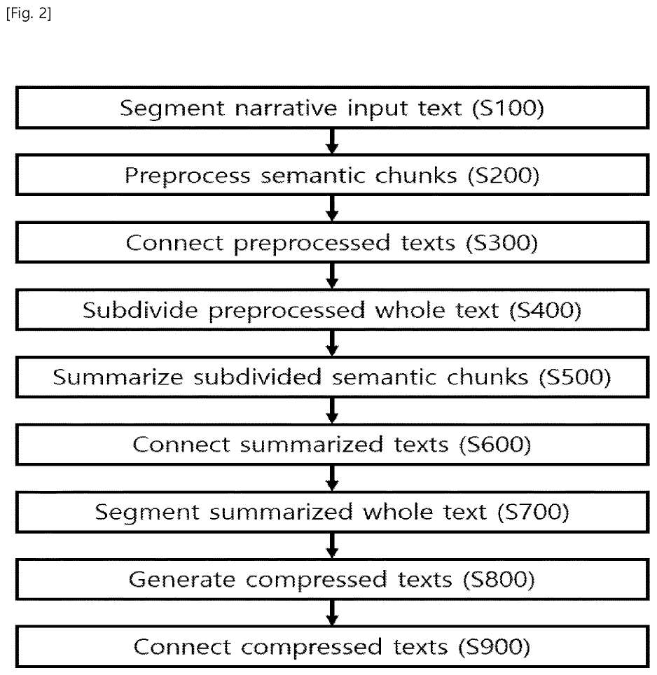

FIG. 2 schematically shows the overall procedure of processing a narrative input text 10 into a final summary 20 through scene-based semantic chunking (S100), descriptive preprocessing of dialogue (S200), combination of preprocessing results (S300), scene-level subdivision (S400), scene-level summarization (S500), combination of summarization results (S600), sentence-level segmentation (S700), sentence-level compression (S800), and combination of compression results (S900).

First, the present invention includes a process of performing scene-based semantic chunking (S100) on a narrative input text 10 containing both dialogues and explanations into scene-based semantic chunks. Here, the scene-based semantic chunk means a section where narrative cohesion is maintained, and may be distinguished on the basis of transition signals such as time change markers, location change markers, event transition markers, and scene transition markers. As the semantic chunking is not merely cutting by length, but is configured to include behaviors and dialogues of characters in a scene and background descriptions together, the narrative structure is maintained in the subsequent processing.

Thereafter, the preprocessing step (S200) is performed on each segmented semantic chunk. The core of the preprocessing step is generating a preprocessed text by converting the dialogue contained in each semantic chunk into third-person descriptive sentences. The first large language model 100 used at this point is not a method of listing dialogue sentences as they are, but is configured to rewrite who said what, the attitude taken at the moment of agreeing or refuting, suggestions that the speaker has made, and how the opponent has accepted or rejected, and the like in sentences in combination with descriptive verbs.

In addition, as the explanatory elements presented in the script, such as stage directions, background descriptions, emotional expressions, motions of characters, and descriptions of situations, are naturally combined with the descriptive result of the dialogue, the meaning of a scene may be organized as a single continuous narrative paragraph. As segmentation of multi-speaker dialogue is reduced and directives and expression of grammatical person is organized to match the context according thereto, the relationship between the characters and events may be traced more stably in the subsequent summarization step.

At this point, since the purpose of the preprocessing is not to perform literary creation, but to normalize the original text to a unified expression format suitable for summarization while maintaining the intent of the original text and event information, it is desirable to configure the process to organize the writing style within a scope that does not undermine the key information of scenes and the interactions between the characters.

When the preprocessing is completed for each semantic chunk, the present invention performs a process of generating a preprocessed whole text by combining preprocessed texts (S300). The combination may be accomplished by connecting the semantic chunks while maintaining the original order, and may be performed by including expressions indicating scene segmentations to preserve scene boundary information, or by ensuring continuity so that at least the order between scenes may not be changed. The preprocessed whole text generated in this way is organized in the form of a narrative prose, in which dialogues and explanations are unified, and the event flow of each scene is maintained in a form relatively clear.

Thereafter, the present invention performs a process of subdividing the preprocessed whole text into scene-based semantic chunks (S400). Since the sentence boundaries and paragraph structures may be changed when the dialogues are converted into descriptive sentences in the preprocessing process, and cohesion of scenes may become clearer, or on the contrary, specific scenes may be extended to be longer, the whole text may be reconfigured once more into scene-based semantic chunks to optimize the unit of input in the summarization step. The subdivision may also be performed on the basis of time, location, and event transition signals, and may form more stable scene chunks by reflecting the cause-and-effect relationship of the events, as well as scene transition expressions revealed within the descriptive sentences generated by preprocessing.

Each subdivided semantic chunk is transferred to the summarization step to generate a summarized text (S500). As the model and role of the second large language model 200 used at this point are distinguished from the model and role of the preprocessing step, key events and interactions between characters are extracted from the scene chunks to create a cohesive summary.

In narrative text summaries, since the structure based on the title or conclusion is not clear like news summaries, summaries may be created focusing on the narrative elements such as the key events occurring in the scenes, goals and behaviors of characters, cause and effect of conflicts, and changes in the relationships.

In addition, when a scene includes several events, the sentence connection of the summary is configured to maintain the chronological order of the events so that the overall narrative flow may be continued naturally in the combination step thereafter.

The present invention includes a process of generating a summarized whole text, when a summarized text is generated for each scene, by combining the summarized texts (S600). The combination may be performed by connecting the summaries while maintaining the order of the scenes, and when characters or events are continued in the next scene, minimal connection expressions may be included not to disconnect the reference so that narrative continuity may be secured. Although the result of combination may function as an initial summary reflecting the entire input, it still may be long or may not satisfy the target length requirements due to the nature of long narratives.

Accordingly, the present invention includes a process of segmenting the summarized whole text at the sentence level (S700). The sentence-level segmentation is for performing compression more precisely, and when sentences are compressed only at the scene level, important connecting sentences may be deleted as a whole, or the degree of compression may be excessively coarse, so that it is desirable to configure to finely adjust at the sentence level.

Thereafter, the result of segmenting a text at the sentence level is transmitted to the compression step, and each sentence chunk is converted into a text compressed as a shorter and denser expression (S800). The third large language model 300 used at this point has a role distinguished from that of the summarization step, and it is configured to remove duplicate expressions while maintaining events and relationships, integrate sentences of similar meanings, and compress verbose modifications or repetitive explanations. As needed, the order of sentences may be maintained so that connection between the sentences in the compression result may not be unnatural, or the flow of reading may be maintained by minimally complementing the connection expressions.

When compressed texts are generated, the present invention may conclude with a process of generating a compressed whole text by combining the compressed texts (S900). The combined result may be provided as a final summary, and is organized into a form that better matches the target length while maintaining the key event flow and character relationships of the entire narrative.

As the steps of preprocessing, summarization, and compression are separately performed through each step according to respective roles, both scene-level meaning preservation and sentence-level length control may be accomplished even in an environment where it is difficult to process a long text input at once.

In addition, the present invention assumes that a plurality of large language models used for preprocessing, summarization, and compression may be configured to share the same model or may be configured of different models. For example, according to the system resources and implementation environments, it may be configured to commonly use a single large language model, but perform preprocessing, summarization, and compression by using a different output instruction in each step, or it may be configured to optimize the descriptive performance of the preprocessing, event capturing performance of the summarization, and the length control performance of the compression by arranging models of different characteristics in each step.

Furthermore, the configuration of model like this may be implemented by providing an output instruction that reflects the object of the task in each step, and structuring the unit of input without additional training or fine-tuning of parameters. This means that it can be realized by structuring the pipeline itself to handle the issues of mixed dialogue structure and long text length that the narrative text has, without requiring training subordinated to a specific dataset.

According to the configuration like this, an effect of enhancing cohesion through description of dialogues, reducing loss of context through scene-based segmentation and combination, and controlling the length of summary more precisely through sentence-level compression is briefly expected even in a narrative text with a lot of dialogues.

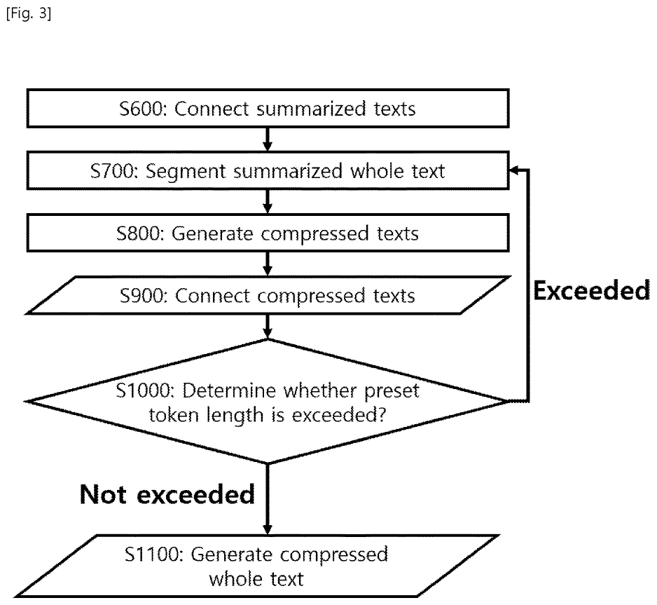

FIG. 3 illustrates a control flow for regenerating a compression result that meets the target length by performing sentence-level segmentation, compression, and combination again when the length of the final compression result exceeds a reference length (S1100).

The “exceeded” indicated in the drawing represents a situation where the length of the compressed whole text generated by the system exceeds a predetermined reference of token length. At this point, the “length” may be determined by the number of characters constituting the compressed whole text, the large language model, or the length of token units calculated by a tokenizer. Immediately after the compressed whole text is generated, the system calculates the token length by analyzing the text using the same tokenization rule, and determines whether the calculated value exceeds a predetermined reference length (S1000). When the condition of “exceed” is met, the flow returns to the previous processing step, and this means that the final output is not determined only by the fact that compression has been performed once, and the regeneration loop operates until the length condition is satisfied.

At this point, the summarized whole text generated in the preceding step or the previous compression result is segmented again into several units of sentences according to sentence boundaries, and each sentence chunk is provided again to the third large language model 300 together with an output instruction configured to perform compression. At this point, the compression may be performed not by simple deletion, but by integrating duplicate event descriptions while minimizing loss of meaning, and combining the parts that repeatedly describe the same character relationships or emotional states into a single sentence, or compressing verbose modifications to leave only the essentials.

In addition, the reason for segmenting at the sentence level is to reduce discontinuity of narrative connection that may occur when compressing at once at the scene level or paragraph level, and to increase the resolution of length adjustment. The results compressed at the sentence level are recombined while maintaining the original sequence of events to reconfigure the compressed whole text, and the reconfigured result is transferred again to the step of calculating token length and determining whether the reference length is exceeded. As shown in the drawing, this process may be repeated until the reference length is satisfied.

When the repetition is indefinitely performed, the narrative core may be damaged as the processing resources are excessively consumed or the content is excessively compressed, and therefore, a predetermined iteration limit may also be applied to iterative control. That is, the present invention may manage the number of iterations, and limit the iteration not to exceed a predetermined limit. When the token length still exceeds the reference length although the iteration limit is reached, the process may be stably concluded by selecting and outputting a result that satisfies the preservation of meaning and condition of length in the most balanced way from the results of the previous iteration step, or by adjusting the strength of the compression instruction and performing the next regeneration, rather than forcibly performing additional compression.

At this point, “selection” or “adjustment” does not change the narrative structure greatly, and it is desirable to implement at a level of slightly increasing the compression of expression or strengthening duplicated integration within a range that does not undermine the cause and effect relationship of characters and events. According, the operation of the system for satisfying the length requirements while securing the quality of summary is not excessively skewed in one direction.

In addition, a preset value, such as a preset number of times, is not limited to be operated as a fixed value, and may also be dynamically calculated according to the scale of input narrative text.

For example, when the total number of tokens in a narrative input text is large, the size of bundles constituting a scene-based semantic chunk or the number of units of processing may vary, and the segmenting strategy may also vary even when the number of scenes detected in the input text is large or small.

Specifically, when the input is very long, the scene-based semantic chunk may be configured further smaller so that each unit may not be excessively long, or on the contrary, when the input is relatively short or the number of scenes is small, the scene-based semantic chunk may be configured more generously so that the narrative flow may not be interrupted by excessive segmentation.

The dynamic calculation like this may be determined by considering both the processing efficiency and information preservation in the preprocessing and summarization steps, and as a result, it contributes to reducing the situations where “exceeded” frequently occur in the compression step.

In addition, although the reference length, which is the target of the iterative compression, may also be set according to the user requirements, constraints in the output media, or usage of the summarization result, in any case, it is desirable that application of the reference length and iterative control are operated according to the purpose of “control the length while maintaining the narrative core”.

As an embodiment, the system receives an input with a high proportion of dialogue and frequent changes of scenes, such as a drama script, segments the input into scene-based semantic chunks and normalizes the dialogue to a descriptive form, and generates an initial summary by combining summaries of each scene according thereto. Thereafter, a compressed whole text is obtained by segmenting the initial summary at the sentence level and combining the results of compressing the segments, and the token length of the result is calculated, and whether the token length exceeds a reference length is determined. When it exceeds the reference length, a shorter compression result is regenerated by performing again the sentence-level segmentation, compression, and combination according to the flow shown in the drawing, and the same length determination is iteratively applied to the regenerated result.

The iteration like this is performed within a predetermined iteration limit, and as the compression instruction is configured in the iteration process to maintain the character relationships and event development, loss of context due to simple deletion may be prevented.

According to the configuration like this, there is an effect of improving the length compliance by automatically performing recompression in a situation where the length of the final output exceeds the requirement, and securing both the processing stability and result consistency even in a long narrative summary by dynamically adjusting the segmenting criteria according to the input scale.

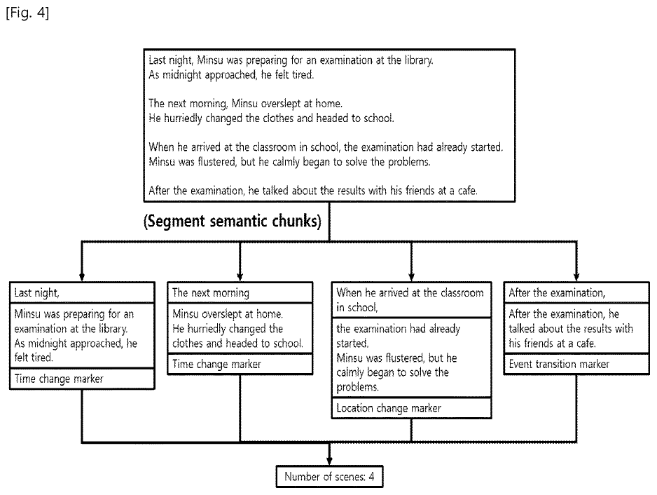

FIG. 4 shows a calculation method, together with an embodiment, related to the criteria for distinguishing a narrative input text 10 at the scene level and forming a unit of processing by grouping a plurality of scenes into a single scene-based semantic chunk, and the criteria for subdividing the preprocessed whole text into subdivided semantic chunks.

The scene-based semantic chunk in the present invention is not a segment piece created by cutting a narrative input text 10 or a preprocessed whole text into pieces of an arbitrary length, but a single semantic chunk formed by grouping scenes where a narrative flow is maintained according to a predetermined rule.

Since the narrative input text 10 or the preprocessed whole text usually includes complex developments such as changes in time and location, shifts in the purpose of characters or situation of conflict, and insertion of explanatory sentences while the dialogue is continued, when semantic chunks are created, it is desirable to follow the order of determining scene boundaries first, and forming a unit of processing by combining a plurality of scenes into one bundle.

Scenes are distinguished on the basis of transition signals included in the narrative input text 10 or the preprocessed whole text. The time change markers may include expressions that directly reveal movements along the time axis, such as the next day, that night, after a short while, or sometime later, and the location change markers may include phrases indicating changes in the spatial background, like the expressions of moving from home to school, going from a room to a street, or entering a specific building or area. The event transition markers may include expressions that imply a moment when the situation of a story changes, such as an examination begins, an explosion occurs, someone appears, or a conflict is resolved, and the scene transition markers may include sentences indicating changes in the scene preface or transition of the screen in a script format, or connection expressions that clearly show that the narrative flow moves to a new scene.

When distinguishing scenes, there are cases where these markers appear individually. However, since it is common in actual narratives that changes in time and location occur simultaneously or an event transition occurs together with spatial movement, the present invention may determine scene boundaries by considering a plurality of markers together.

For example, when “classroom in school” is mentioned after “the next morning” appears in a narrative, and an event transition of “examination has already started” is followed, it is natural that the point is considered as a strong boundary combining time, location, and event transition, and the scene is separated. On the contrary, although the markers exist, there are cases where the immediately next sentence may conclude the result of the previous scene, and thus, the narrative cohesion may be lowered when the boundaries are established immediately. In such cases, it may be adjusted not to disconnect the cause-and-effect relationship in a scene with reference to the context before and after the boundary candidate together.

After the scenes are distinguished, the scene-based semantic chunks are configured to include a preset number of scenes. The preset number may be understood as a balance point for reducing the problem of disconnecting the context, which is generated by treating only a scene as the unit of processing and breaking it down too finely, while preventing the model input from being excessively long as the semantic chunk is excessively large. That is, the semantic chunk uses a scene as a unit, and it is configured by grouping a predetermined number of scenes into a single unit of processing, and therefore, each unit of processing provides a segmentation structure for handling the whole text until the end of the text, while maintaining natural connections between scenes within a predetermined range.

In addition, the present invention assumes that the preset number is not limited to be operated only as a fixed value, but may be dynamically calculated according to the scale of the narrative input text 10 or the preprocessed whole text. When the total number of tokens in the narrative input text 10 or the preprocessed whole text is very large, and the same criterion is applied as is, the number of semantic chunks excessively increases, or on the contrary, as the semantic chunk increases excessively long, and thus the processing efficiency may be lowered, the present invention may adjust the criteria for configuring the semantic chunks by considering the scale of input tokens.

In addition, when the number of scenes detected in the input text is large, the configuration of scene bundles may vary, and when the number of scenes is small, the scene bundles may be configured differently to avoid unnecessary segmentation.

For example, in a script-type input where transition between scenes is very frequent as the number of scenes is too large, each semantic chunk may be configured not to include too many scenes to prevent the information density within a scene from being excessively high, and on the contrary, in a novel-type input where the number of scenes is relatively small and each scene is developed long, the scene bundles are configured not to be excessively small so that motivation of characters and the cause and effect of events may be sufficiently revealed within a single unit of processing.

As an embodiment, the preset number may configure a semantic chunk according to a value calculated by dividing the total number of scenes of the narrative input text 10 by a predetermined value. For example, a semantic chunk may be configured according to a value calculated by dividing the total number of scenes by 8, and it is desirable to form 5 to 10 scenes into one chunk considering the balance between context preservation and processing efficiency.

In particular, when eight scenes are set as a single semantic chunk, narrative continuity and token efficiency may be maintained stably.

This dynamic calculation is not limited to the purpose of simply matching the length, and it may be a basis for helping the flow of scenes to be maintained stably in the summarization step after normalizing the dialogues and descriptions to a unified prose in the preprocessing step.

As an embodiment, the present invention receives a narrative input text mixed with dialogues and explanations, and first, detects sentences indicating expression of changes in time, expression of changes in location, and transition of situation in an event to set candidates of scene boundary. Thereafter, the scene boundary is finalized in a direction of naturally connecting behaviors of characters with the cause and effect of events by comparing situations before and after the candidate boundary, and the finalized scenes are arranged in order.

Next, the system calculates scene bundle criteria on the basis of the scale of tokens or the number of scenes in the entire input, and configures scene-based semantic chunks containing a plurality of scenes according to the criteria. The semantic chunks configured in this way may be provided as an input in the preprocessing step so that third-person description of the dialogue is performed in units of semantic chunks, and after being combined into a whole text, the semantic chunks may be reconfigured again at the scene level and used as an input of the summarization step.

When configuration of the scene-based semantic chunks is excessively dense in this process and there is a concern that subsequent steps become unstable, the scene bundle criteria may be readjusted or determination of boundary candidates is supplemented in this process so that the scene-based structure may sufficiently reflect the narrative cohesion.

For example, when a scene preface exists in the script, it is treated as a strong location change marker, and when a sentence that continues the conclusion of the immediately preceding scene exists, the boundary may be finely adjusted to include the conclusion to prevent discontinuity of scenes, and in sections where dialogues are continued, it may be configured so that the scene unit comprehensively includes the flow of dialog by preventing the scenes not to be segmented only by taking turns of speech.

When scenes are distinguished by the transition marker in this manner, and scene-based semantic chunks containing a plurality of scenes are flexibly configured according to the input scale, it is expected that the unit of processing may be stably formed even in a long narrative text while maintaining the narrative flow.

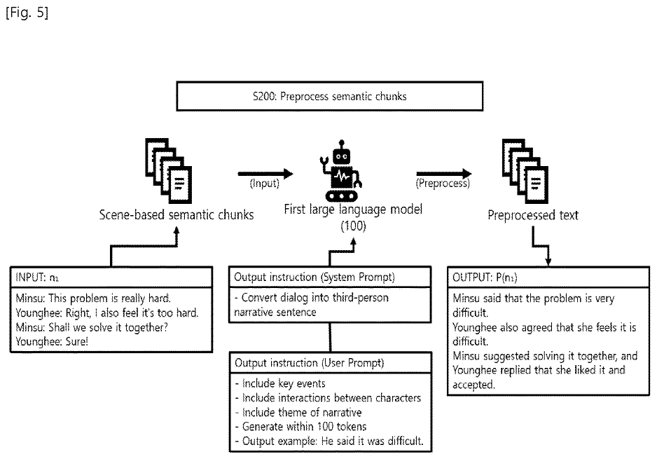

FIG. 5 shows the core configuration of the preprocessing step (S200), in which dialogs included in a semantic chunk is provided to the first large language model 100 together with an output instruction, and converted into a third-person descriptive sentence.

Dialogues between characters may be included in the input text segmented into scene-based semantic chunks, together with descriptive narratives. Therefore, the preprocessing step (S200) aims at normalizing dialogues and explanations to a unified narrative prose structure so that the subsequent summarization step may stably follow events and character relationships, rather than simply changing in the form of dialogue.

To this end, in the preprocessing step (S200), an output instruction configured to identify a dialogue section in each semantic chunk, and convert the dialogue into a third-person descriptive sentences, together with a corresponding dialogue segment, is provided to the first large language model 100. The output instruction is configured to reduce the segmentation and ambiguity of the instruction target generated due to the spoken language, while preserving the unique information and intent of the input text, and to naturally maintain that the conversion result is a preprocessed narrative text, rather than simple summarization or compression.

The output instruction may request that the preprocessing result should reflect at least one among a key event, interactions between characters, or a theme of narrative in the descriptive sentence. Here, the key event means an event-based unit that includes behaviors or changes actually occurred in a scene, occurrence and resolution of conflicts, and decision-making and its consequences, the interactions between characters means dialog behaviors that change the relationships between characters, such as agreement, rebuttal, proposal, acceptance, conflict, and cooperation, and the theme of narrative means the meaning of narrative, such as the axes of values, emotions, and conflicts that repeatedly appear in a scene.

For example, when the input is configured focusing on dialogue such as “Minsu: This problem is really hard. Younghee: Right, I also feel it's too hard. Minsu: Shall we solve it together? Younghee: Sure.”, the preprocessing result may summarize the event flow and interactions in a descriptive form, such as “Minsu said that the problem is very difficult and recognized the difficulties. Younghee agreed that she felt the same difficulty and showed an attitude of empathy. Minsu suggested solving it together, and Younghee accepted it positively”.

At this point, rather than the result sentence is limited to the level of ‘there was dialogue’, it is desirable to configure the result sentence to reveal the development of decision-making and changes in the relationships that the dialog implies.

The output instruction may also request to generate a text that satisfies a preset token length. Unlike the length control in the summarization step, the length control in the preprocessing step is not intended to induce omission of events, but to organize the unit of input in a range that can be stably processed in the subsequent steps.

Accordingly, the preprocessing result may satisfy the length requirements by reducing unnecessary expressions, organizing repetitions or minor exclamations, and neatly changing the flow of spoken language into a descriptive form within a scope that does not undermine the meanings of the scenes.

For example, exclamations such as “Good!” may be organized as “accepted”, “affirmed”, or the like, and when the emotion of a scene is important, it may be configured by reinforcing only within a scope that emotional information contributes to formation of core events or theme, such as “willingly accepted” or “agreed with relief”.

The output instruction may include example pairs of text corresponding to the input and output. The example pairs are intended to stably induce a conversion style suitable for a specific genre or writing style, and phrases of spoken language presented as an input and descriptive conversion statements presented as an output are provided together so that the model may follow expected conversion rules.

For example, a dialogue sentence containing a speaker marker and a brief background explanation may be presented as an input example, and a paragraph in which the cause and effect of events and interactions of characters are preserved although the dialogue is converted into a third-person descriptive sentence may be presented as an output example. The example pairs are not limited to specific works, but may be provided in a manner that shows general conversion patterns, and as a result, consistency and reproducibility of the preprocessing step is improved.

In the preprocessing step (S200), overlapping sections may be included to minimize discontinuity of context between semantic chunks. When the input is segmented into scene-based semantic chunks, sentences that connect the result of the previous event or overlap with the beginning of the next scene exist near the scene boundaries in many cases. At this point, when each semantic chunk is processed after being completely separated, the motivation of characters or the cause of events may appear to be disconnected, and therefore, a method of commonly including some sections near the boundary in both semantic chunks and organizing the description so that the overlapping may not be excessively revealed in the preprocessing result may be applied.

For example, when a sentence “Minsu hesitated” in the previous scene is an important clue for understanding the dialogue in the next scene, the sentence may be included be referenced from both sides of the boundary, and the connection expressions may be supplemented in the preprocessing result so that the preceding and succeeding contexts may be connected naturally.

In addition, the preprocessing step (S200) may be processed to normalize the referential expressions, nicknames, and titles to the same person. In dialogs, titles and reference terms such as “senior”, “older brother”, “that person”, and “that friend” are frequently used, and according to works, the same person may be alternately referred to by a nickname or a real name. Since tracing of a character may be shaken in the subsequent summarization step when these expressions remain as they are, the preprocessing step may be configured to interpret a reference target using the context and speaker information, and to use the notations normalized to the same person within a possible scope.

For example, when “Minsu” is called “Minsu-ya” or referred to by a nickname during dialog, continuity of character relationships may be secured in the preprocessing result by maintaining a unified notation for the same person. However, when the nickname itself has a narrative meaning due to the nature of the work, a method of describing both the real name and the nickname, instead of removing the nickname, is also possible so that readers may not be confused with the character.

In addition, the preprocessing step (S200) may be normalized so that the tense, narrative perspective, and writing style may be consistent. Present-tense directives, imperatives, and exclamations are mixed in a script or a dialogue sentence, past and present forms may be mixed in explanatory sentences, and speeches of characters are configured in the form of a spoken language. When these mixtures are maintained as they are in the preprocessing step, the writing style may be inconsistent in the subsequent summarization step, and therefore, the preprocessing result may be unified on the basis of a descriptive writing style of a third person perspective, and the tense may be organized to match the time flow of events.

For example, a speech such as “Let's go now” is converted into a descriptive form such as “suggested to start soon”, and when the entire scene is a flashback structure, a method of matching tense consistency by including time expressions such as “at that time” may be applied.

In addition, descriptive sentences of the preprocessing result may reflect the temporal location of dialogue or event. In narrative texts, time markers such as “that night”, “next morning”, and “after a short while” are key clues for understanding the cause and effect of an event, as well as distinction of scenes.

Accordingly, when the time point of occurring dialog is important in the preprocessing step, a corresponding time marker may be naturally included in the descriptive sentence to maintain the location of the event, such as in “That night, Minsu confided that it is difficult”. Even when the scene headings or background descriptions in the script imply time information, the information may be combined with the description of dialog in the preprocessing result without omitting the information so that the background of the event can be maintained.

In addition, in order to determine the reliability of the third-person descriptive text generated in the preprocessing step (S200), a verification step of calculating an n-gram overlap rate between the preprocessed text and the original input text may be further included. The overlap rate may be calculated in units of 2-grams or 3-grams, and may be used as a criterion for identifying the cases where the original dialog text is duplicated as is or is limited to the level of simply changing the order of words.

For example, it may be configured to perform reconversion when consecutive n-grams of a predetermined length or longer are maintained to be the same as the original text, and on the contrary, when it is determined that semantic reconfiguration has occurred, the preprocessing result may be confirmed as valid.

The verification like this may operate as an auxiliary means for quantitatively determining whether the dialog has been substantially reconfigured into a third-person narrative, and may be configured to perform reprocessing as needed when the overlap rate exceeds a preset threshold.

Through the preprocessing step (S200), semantic chunks containing dialogue are provided to the large language model, together with the output instruction, to be converted into third-person descriptive sentences, and events, interactions between characters, and thematic elements are reflected in the conversion process, and consistency of the result can be secured through style induction based on the length requirements and example pairs.

In addition, as contextual continuity is secured through overlapping sections, reference terms are normalized, tenses, perspectives, and styles are unified, and temporal location is reflected at the same time, the preprocessed text may be provided in a form suitable for the subsequent summarization and compression steps.

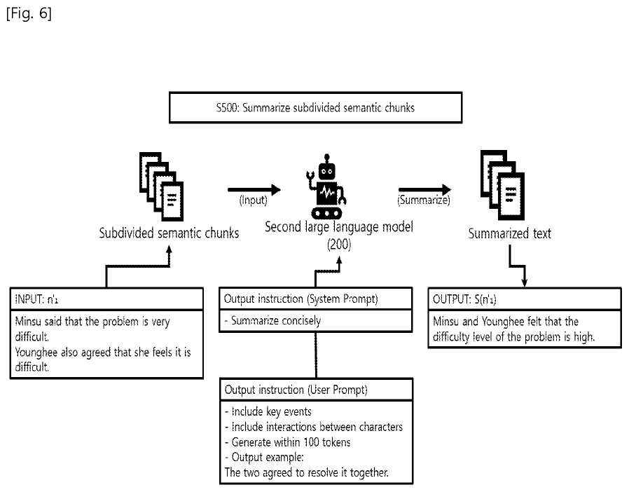

FIG. 6 shows the core configuration of the summarization step (S500), in which semantic chunks reconfigured from the preprocessed whole text are provided to the large language model together with the output instruction, and converted into scene-level summary text.

Unlike the description of dialogue performed in the preprocessing step (S200), the summarization step (S500) may perform a function of creating a framework for summary that represents the entire narrative by capturing the event flow at the scene level and organizing changes in the character relationships and development of conflicts.

Since the subdivided semantic chunks are generated by reconfiguring the whole text combined with the preprocessing results on the basis of scenes, each semantic chunk may include sentences already normalized in the third-person narrative form, and sentences containing the background of scenes and behaviors of characters in an explanatory form. Since the input like this resolves the ambiguity in the instruction targets of spoken language to a large extent, and organizes tenses and narrative perspectives relatively well, the core of events and changes in the relationships may be reliably extracted in the summarization step.

However, since the same character or event may be mentioned repeatedly across several sentences or important clues may be scattered in the front and rear parts of a scene due to the nature of long narratives, it is desirable to perform summarization by reconfiguring information in the scene and integrating the information into an event-based narrative, rather than simply compression of sentences.

In the summarization step (S500), an output instruction configured to summarize each subdivided semantic chunk is provided to the second large language model 200. The output instruction may request that the summarization result includes at least one among a key event, interactions between characters, and the theme of narrative, and may induce to naturally select an event-based summary, a relationship-based summary, or a theme-based summary according to the nature of scenes.

The key event includes behaviors, turning points, and results that actually occurred within a scene, and the interaction includes relational changes between characters, such as cooperation, conflict, persuasion, betrayal, and reconciliation. The theme includes semantic elements such as the emotional axis conveyed by a scene, recurring value judgment, and root cause of conflict.

For example, when a preprocessed input consecutively includes statements such as “Minsu said that the problem is difficult”, “Younghee agreed”, “Minsu suggested solving it together”, and “Younghee accepted” within a scene, the summarization result may be generated in a form that reflects both events and interactions, such as “The two shared the difficulty of the problem and agreed to solve it together”. On the contrary, when the scene is configured of background description and internal monologue of a character, the summarization may put more emphasis on the theme or emotional change than on the result of an event, and express by compressing the meaning of a scene, such as “the character was conflicted between fear and determination”.

The output instruction may request that the summarized text may satisfy a preset token length. At this point, the purpose of length control is different from that of length organization in the preprocessing step, and it may function as a mechanism for preventing the overall summary from being excessively long when the results of scene-level summarization are combined, and maintaining a summary density of each scene to be consistent.

That is, the summarization step (S500) may instruct to create a summary of each semantic chunk within a predetermined token length to prevent a situation of growing the length of the overall summary so much as not to be controllable, as the summary of each scene is excessively verbose.

In addition, in the compression step (S800), a target number of tokens (θ) representing the target length of summary may be set, and a compression threshold (δ) representing the maximum number of tokens allowed in each sentence chunk may be set. The system may be configured to perform additional compression, when the total length of the summarization result exceeds the target number of tokens, according to the exceeded degree by comparing the token length of each sentence with the compression threshold.

When L is the actual number of tokens in the entire summary, and L exceeds the target number of tokens (θ), it can be determined that there are exceeded tokens, and the exceeded tokens may be defined by the difference between L and the target number of tokens (θ). When there are exceeded tokens, the number of tokens in each sentence chunk may be compared with the compression threshold (δ) to perform additional compression preferentially on the sentences that exceed the threshold.

At this point, whether or not to compress may be determined by considering the importance score of the sentence, whether or not key events are included, or whether or not character identifiers are preserved, in addition to simple comparison of length.

As an embodiment, when sᵢ is the number of tokens in each sentence and wᵢ is the importance weight of the sentence, the priority of a compression target may be calculated by a combination of sᵢ and wᵢ, and for example, sentences with a low importance compared to the number of tokens may be preferentially selected as a compression target. The importance weight may be calculated on the basis of frequency of appearance, association with key events, influence on the narrative development, and the like.

In addition, when the compression is performed iteratively, the total number of tokens L is recalculated at each iteration step and compared again with the target number of tokens (θ), and the compression may be performed until L is satisfied to be smaller than or equal to the target number of tokens (θ).

However, at this point, the number of repetitions may be limited within a preset value or range in consideration of system stability.

Although the target number of tokens (θ) and compression threshold (δ) may be set as fixed values, they may also be dynamically calculated on the basis of the total number of tokens, the number of scenes, and the average sentence length of the input text, or a summarization ratio requested by the user.

However, since the importance of each scene in the narrative text varies, and scenes containing turning points of an event may request more information, length requirements may be applied flexibly according to the importance of the scene or the scale of the input.

For example, a result may be induced in a method of assigning a priority to a scene containing the beginning or climax of a conflict so that both the cause and effect of the event may be contained within the same length constraint, and compressing explanatory scenes more intensively to leave only the essential background information.

In addition, the output instruction may include example pairs of input and output, and this functions as a means for clearly conveying a summary style and criteria for including information. The example pairs may be provided in a form that includes a partial excerption of a subdivided semantic chunk, together with a summary example corresponding thereto, and the example summary may show expected output formats, such as a method of maintaining names of characters, a method of describing events focusing on verbs, a method of organizing the theme of scene in a single sentence, and the like.

When the example pairs are included, as the model is easier to follow a specific style compared to an abstract instruction of “summarize”, the writing style and information density of the summary of each scene become uniform, and the phenomenon of abruptly changing the sentence tone is reduced even in the overall summary after the combination. In addition, a method of indirectly training a sense of length is also possible by including an output example that is close to the target token length in the example pairs, and according thereto, more stable length compliance may be accomplished together with explicit length requirements.

In addition, in the summarization step (S500), a configuration of performing summarization by assigning weights to the characters, objects, or events that frequently appear in each semantic chunk may be applied. In a long narrative, the same name or title of a character, the name of a specific object, or keywords of recurring events appear several times in a scene, and this is an important signal showing the focus of the scene.

At this point, the summarization step (S500) may identify entities that frequently appear in the subdivided semantic chunk, and configure an output instruction to preferentially include behaviors where the entities participate or changes in the relationship in the summarization result, or induce to internally emphasize such elements in the description when generating a summary.

For example, when “Minsu” appears repeatedly in a scene and event-related expressions such as “examination”, “lateness”, and “flustered” appear intensively, the summarization result may be configured around the event axes of Minsu's behavior and examination, and include a sentence that anchors the scene, such as “Minsu faced a crisis in a situation of examination and tried to resolve it”.

In addition, when interactions between two characters are frequent, it is highly likely that the frequency of verbal expressions, which show taking turns of speech or interactions, will be repeated, and therefore, the summary may be configured to preferentially reflect changes in the relationship and the direction of agreement or conflict. This weight-based emphasis may provide practical assistance in creating summaries that do not miss the core factors in a scene, without requesting separate learning.

As an embodiment, in the summarization step (S500), the preprocessed whole text may be subdivided to obtain each semantic chunk, and then a summary output instruction may be configured for each semantic chunk. The output instruction may include conditions that request to reveal interactions between characters as clearly as possible without omitting key events occurring in a scene, and reflect, when a theme conveyed by the scene exists, the theme in a single sentence or phrase. In addition, the length requirements may be included so that the summarization result does not exceed a predetermined token length, and input and output example pairs showing the desired writing style and information density may be included together so that the summarization result may have a uniform style for each scene.

At this point, in the summarization step (S500), keywords of characters and events with high frequency of appearance in the semantic chunk are calculated, and the results may be reflected in the summary output instruction or used as a priority for generating a summary so that the summary maintains the central axis of the scene. Summaries generated for each scene in this way are connected in the combination step while maintaining the original order of scenes to form a draft of the overall summary, and subsequently, length control may be performed more precisely in the sentence-level compression step.

In addition, the summarization step (S500) may further include a verification procedure of calculating the n-gram overlap rate between the generated scene-level summary text and the corresponding input semantic chunk in order to confirm relevancy of the summarization result. The overlap rate may be utilized as an indicator quantitatively indicating the similarity of expression between the input scene text and the summarization result, and may be used as a criterion for detecting occurrence of excessive sentence duplication or reproduction of the original text.

In particular, since summarization of a narrative text aims at reconfiguration of key events and character relationships, rather than simple excerption, it may be configured to adjust the summary strategy or perform summarization again when n-gram overlap of a predetermined level or higher is detected. On the contrary, it may be configured to additionally review whether important information has been excessively omitted, when the overlap rate is excessively low and it is difficult to identify key events.

The verification structure like this may also be used as an auxiliary criterion for determining whether a scene-level summary is accomplished in the form of an abstract reconfiguration.

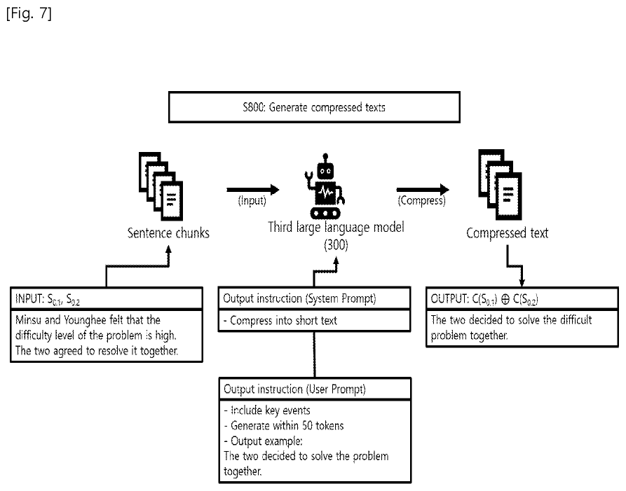

FIG. 7 schematically shows the flow of providing sentence chunks to the third large language model 300, together with a compression instruction, while a summarized whole text is prepared at the sentence level, and converting the sentence chunks into a compressed sentence-level result (S800).

In the compression step (S800), since the input is a summary that has already been formed through the scene-level summary (S500), the purpose of compression is not to create a new content, but to organize the overall length at a manageable level by removing duplication and concisely reconfiguring the expressions while maintaining the event flow, character relationships, and thematic clues included in the existing summary.

Accordingly, through the compression step (S800), an output instruction configured to compress the sentence chunks is provided to the third large language model 300 together with the sentence-level text, and according to the instruction, the third large language model 300 may generate a compressed sentence-level result by compressing the sentences, integrating duplicated meanings of adjacent sentences, or removing parts that repeat the same fact in different expressions.

The output instruction may be configured to request that the compression result includes at least one among a key event, interactions between characters, and the theme of narrative. Here, the key event is a semantic chunk, which includes behaviors and consequences that move development of events, beginning and transition of a conflict, and changes corresponding to the conclusion in the summary, and the interactions between characters include interactions that change the relationships, such as agreement, rebuttal, proposal, acceptance, cooperation, betrayal, and reconciliation.

In addition, the theme of narrative includes semantic elements that penetrate the context, such as recurring value judgment, emotional axis, and the direction indicated by the main conflict of the story. Since the compression step should be performed by reducing the number of sentences and the length of sentences without deleting these elements, it is desirable that the output instruction is configured to include criteria for determining chunks to keep and to remove, more than the level of simply saying “write briefly”.

For example, the event-based agreement such as “two people share the difficulty of the problem” and the interaction such as “they decide to solve it together” should be treated as key events that remain even after compression, and on the contrary, modifications or exclamations that repeat the same meaning, or description of the atmosphere that does not add new meaning may be derived as the target of compression.

In addition, the output instruction may be configured to request generation of a text that satisfies a preset token length. The reference of length at this point may be the number of characters, and the length of token according to the tokenization rule may also be applied as the reference, and when the results of sentence-level compression are recombined to form a full compressed summary, it may function as a safety device keeping the target length not to be exceeded.

When the length requirements are applied at the sentence level, compared to a method of drastically reducing the entire text at once, the narrative connections may be less damaged, and the phenomenon of excessively cutting off only specific sentences can be mitigated.

However, since information density of the narrative summaries is not uniform, length requirements may be applied in combination with importance of sentence, and sentences containing key events may be induced to apply compression or integration, rather than being deleted.

In addition, the output instruction may include example pairs of text corresponding to the input and output. These example pairs are means for instructing the model to clearly follow the conversion pattern expected in sentence-level compression, and an example input may include a combination of sentences that describe duplicate facts in expressions different from each other, and an example output may include a short sentence in which the names of characters and results of events are preserved while duplications are removed.

In addition, the example pairs may be configured to naturally reveal the criteria, such as a verb used when a speech behavior indicating interactions is compressed, and the level of specificity to be maintained not to make it difficult to trace events when the thematic sentences are too abstract.

According thereto, the writing style of the compression result and the method for including information are consistently maintained in all sentences.

The sentence-level compression (S800) may be performed on the basis of importance. The system may calculate an importance score for each sentence of the summary, and process to remove or compress sentences starting from those with a low importance. The importance score may be calculated on the basis of the presence of character names included in the sentences, verb structures indicating events, connection expressions linking the cause and effect, relational expressions containing the cause and effect of conflict, or associations with key entities emphasized in the scene summarization step.

Although sentences of low importance may be candidates that can be completely deleted, since the connectivity is important in the narrative summaries, it is desirable to apply compression first instead of deletion or to leave a minimal connection link in association with adjacent sentences so that the deletion does not immediately lead to disconnection of cause and effect. On the contrary, although sentences of high importance become the target of compression, since the core meaning should be maintained, they may be processed in a way of changing choice of words concisely or removing duplicate modifications.

In addition, in the compression step (S800), preset protection rules may be applied so that the character names, event identifiers, key relationships, or key events may not be removed. The protection rules may be implemented by prohibiting complete deletion and enforcing compression or integration although a sentence containing a specific name or an event marker is classified as a candidate for deletion, or by specifying expression elements that should be included in the compression result so that sentence structures representing the key relationships may not be disappeared.

For example, when a change in the character relationships becomes a turning point of a narrative, since the change should be maintained even as a short expression, the protection rules may be operated in combination with the compression instruction to preserve the expression of the relationship. The protection rules may be enforced through the constraints of the output instruction and post-hoc verification without additional training of the model itself, and this may function in a direction enhancing the stability in an actual implementation.

In addition, when the sentence-level compression is repeatedly performed, information removed or compressed in each iteration step is recorded, and removal or inclusion may be controlled in subsequent iteration step with reference to the records. Here, the record is not merely a list of deleted sentences, but may include details, such as key events to which the deleted information is connected, character names or event markers with which the deleted information is associated, and whether loss of meaning has occurred before or after the compression.

Next, in the iteration step, constraints may be applied to prevent background explanations that have already been removed from being reintroduced at length by other sentences, and on the contrary, when the cause and effect of events become unclear as the connection information is excessively omitted during the iteration, adjustment may be performed to include minimal connection information again using the records. Even in this case, it is desirable to preferentially apply the protection rules so that the character names or key events may not be distorted or newly created in the recovery process.

As an embodiment, in the compression step (S800), after a summary combined with a scene-level summary is segmented at the sentence level, an importance score is calculated for each sentence, and compression is performed first on the sentences with low importance, and duplicate information may be removed as needed by integrating the sentences with adjacent sentences.

In this process, sentences containing character names, event results, and key relationships are restricted from being deleted by the protection rules, rewritten in more concise expressions if possible, and the event flow is maintained even after the compression.

At the same time, in the compression step (S800), information removed or compressed in each iteration is recorded, and the record is reflected in the next iteration so that the same information may not appear again or important connection links may not disappear.

In addition, the output instruction may include a request for maintaining key events, interactions, and topics to clarify the direction of the compression, a request related to the target length of token, and example pairs showing how integration and deletion of sentences should be performed.

In addition, the compression step (S800) may further include a verification step for calculating the n-gram overlap rate between the summary before compression and the summary after compression in order to determine reliability of the compression result and preservation of meaning. The overlap rate may be utilized as an indicator that determines whether the compression process is performed simply based on deletion or whether the expressions are rearranged while reconfiguring the meaning.

For example, when the result after the compression corresponds only to partial deletion of the sentence before compression, a predetermined level of n-gram duplication may be detected, and in this case, it may be configured to additionally perform integration based on the importance or compression for expressing the sentence again.

In addition, in order to secondarily confirm whether the key events, character names, or key relationships are removed in the compression process, it may be configured to refer to n-gram-based comparison results, together with the protection rules.

The verification like this may also be utilized as a complementary determination tool for maintaining the balance between length control and preservation of meaning in the iterative compression step.

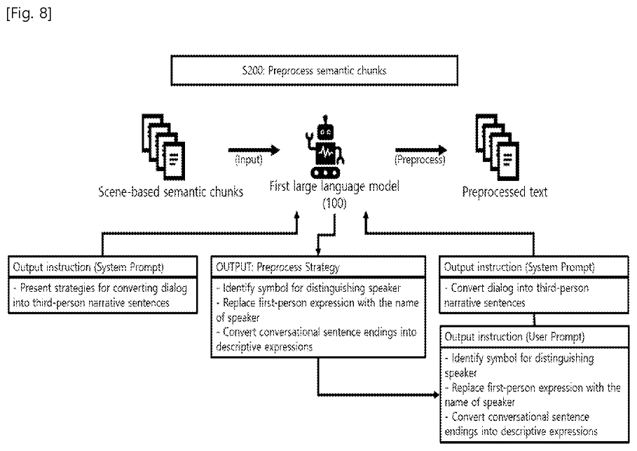

FIG. 8 schematically shows a configuration, in which the output instruction used in the preprocessing step (S200), the summarization step (S500), and the compression step (S800) is dynamically generated according to the nature of input text and intermediate outputs, and the generated output instruction is provided for processing of the large language model 100, 200, 300 in each step.

Like texts containing dialogues, semantic chunks reconfigured based on scenes, or sentence chunks segmented from a summary, texts may be formed at different points in the pipeline. These texts are not limited to a method of repeatedly using instructions of the same format at each step of preprocessing (S200), summarization (S500), and compression (S800), and may also generate an effective output instruction strategy based on the content actually provided in each step (S200, S500, S800). According thereto, the input genre and style, proportion of dialogue, density of scene transition, and requirements on the length of summary may be reflected more precisely in each step (S200, S500, S800).

Generation of an output instruction may be performed by utilizing at least one of the large language models 100, 200, 300 already in use, rather than relying on separate training or changes of model parameters. The output instruction may be generated by receiving a dialogue text itself as an input, and deriving a conversion strategy such as “change the dialogue into a third-person narrative while maintaining emotions and speaker's characteristics”, by receiving subdivided semantic chunks as an input, and deriving a summarization strategy such as “summarize within a predetermined length focusing on key events and interactions between characters in each scene”, or by receiving a sentence chunk as an input, and deriving a compression strategy such as “reduce the length while removing duplications and protecting key events and relationships”.

As described above, the input candidates used for generating the output instruction are not limited to one candidate, but may be selected or combined according to the information requested in each step.

When the output instruction is generated with reference to the input text, the generated instruction may be used again for processing the step.

For example, in the preprocessing step (S200), characteristics such as whether the work is in the form of a script or a novel, whether the speaker marker is clear, whether a scene preface exists, and whether the emotional expression of the dialogue is strong may be different from each other in the process of converting a semantic chunk containing dialogue into a descriptive form, and when the output instruction is generated on the basis of the input dialogue, a conversion strategy reflecting the difference may be included.

As an embodiment, the first large language model may be configured to internally establish a conversion strategy by analyzing the structure of input text, relationships between speakers, tones of speaking, emotional arc, tense, and interaction patterns between characters before directly converting the dialog into third-person descriptive sentences. The conversion strategy may include unification of narrative perspectives, normalization of referential expressions, whether or not to rearrange temporal flows, and criteria for determining information that can be omitted, and may be generated through a chain-of-thought (CoT).

In some inputs, polite languages and informal languages alternately appear to show the relationships of characters, while in other inputs, nicknames and titles appear frequently to make tracing of the characters difficult. In still other inputs, as there are many stage instructions, explanation is more important than dialogues in some cases.

The step of generating an output instruction analyzes the characteristics of these inputs to establish specific guidelines including a method of normalizing referential expressions and titles to the same person, a method of consistently unifying the tense and narrative perspective, a method of reflecting the temporal location where an event occurs in the sentence, and a method of reducing discontinuity of context by utilizing overlapping segments at the boundaries of semantic chunks. The generated guidelines are immediately used as instructions in the conversion step so that preprocessing results are produced more stably in accordance with the input characteristics.

Even in the summarization step (S500), the output instruction may be generated with reference to the subdivided semantic chunks. In the narrative text, since the importance and information density vary significantly in each scene, some scenes may include turning points of events and the core of conflict, while others scenes may focus on setting the atmosphere and describing the background.

When the output instruction generation step receives subdivided semantic chunks as an input, the guide on what should be focused on to summarize in each scene may be further specified.

For example, structures including the characters and event clues that frequently appear in a specific scene, sentences where the cause and effect of conflicts appear, and whether the interactions are cooperative or confrontational are identified, and a request instructing to necessarily include the key events, interactions, or thematic elements in the summarization result may be reflected in the instruction.

In addition, length guidelines on how to allocate a summary length to each scene may be included to satisfy the overall summary length requirements, and a method of including the input and output example pairs in the instruction to uniformly maintain the writing style is also possible.

At this point, the example pair is not duplicating the unique expression of a specific work as is, but is provided in a form that shows the narrative style and level of information inclusion generally expected in the summary of a scene, so that it may be configured to be an instruction that may also be applied to various inputs.

Even in the compression step (S800), the output instruction may be generated with reference to sentence chunks. Although the compression step is a process of making the summary shorter, since the core of narrative summarization lies in maintaining the event flow and relationships of characters, the output instruction generation step may analyze a sentence-level set to construct rules regarding what to protect and what to reduce.

For example, priority rules may be included to set sentences or expressions containing character names, event identifiers, key relationships, or key events as protection targets to restrict deletion, set sentences that repeat the same meaning as an integration target, and combine the sentences into a single sentence, and compress or remove sentences starting from those with a low importance.

In addition, it may include a strength instruction on the strength of compression in accordance with the target token length, and include an example pair showing the expected result of sentence integration to induce the model to consistently perform compression of a from such as “reduce redundancies while leaving key events and interactions”.

In a structure that repeats compression, information removed or compressed in each iteration step is recorded, and with reference to the records in the next iteration step, the output instruction may reflect the adjustment of preventing the background descriptions that have already been removed not to appear again or restoring minimal connection expression when the connection information has excessively disappeared.

The output instruction generation structure shows that the output instruction may be adaptively generated in steps on the basis of inputs and intermediate outputs, more than being configured of only fixed phrases. At this point, the large language model used to generate the output instruction may be the same as the models 100, 200, 300 used for preprocessing, summarization, and compression, or may be configured to be used only in some steps, or according to the implementation environment, a single model may operate to perform both instruction generation and main processing by distinguishing the purpose of the instruction.

In addition, the output instruction generation does not need to be performed for all inputs at all times, but it may be applied flexibly by using basic instructions when the input is normalized to a specific format or when the need for generating the instruction is low as example pairs are already sufficiently provided, and on the contrary, by performing instruction generation with reference to the input when preprocessing is highly likely to fail since the dialog is complex or there are many nicknames and reference terms, when the focus of the summary is easy to be shaken as scene transition is dense, or when compliance with the target length is difficult.

The flexibility like this may correspond to supplementary explanation needed to obtain stable results in an environment of diverse input genres and narrative structures.

In an embodiment, when the system detects that dialogue is cut short and titles frequently alternate in the input of a script format, a preprocessing instruction including a rule for normalizing the titles and referential expressions to the same character and a rule for specifying the speech behavior as a verb in the third person description is generated in the instruction generation step. Subsequently, an instruction for extracting characters and event clues that repeatedly appear in the subdivided semantic chunks and summarizing them based on the elements thereof is generated in the scene summarization step, and a compression instruction including a rule for compressing sentences starting from sentences with a low importance, and specifying sentences containing character names and key events as protection targets is generated in the final compression step.

When the output instructions generated in this way are applied together with the input of each step, the flow may improve consistency of the preprocessing results, centrality of the summary, and length compliance of the compression.

Although specific embodiments of the narrative text summarization method and the system for the same according to the present invention have been described above, the present invention is not limited to the embodiments. Various modifications, changes, additions, or substitutions may be made by those skilled in the art without departing from the scope and technical spirit of the present invention, and all such modified embodiments should also be interpreted as being included within the scope of the present invention.

### DESCRIPTION OF SYMBOLS

10: Narrative input text
20: Compressed whole text
100: First large language model
200: Second large language model
300: Third large language model

1. A narrative text summarization method comprising the steps of:
(a) segmenting a narrative input text containing dialogues and descriptions into a plurality of scene-based semantic chunks;
(b) generating a plurality of preprocessed texts by converting the dialogue contained in each of the semantic chunks into third-person descriptive sentences using a first large language model;
(c) generating a preprocessed whole text by connecting the plurality of preprocessed texts;
(d) subdividing the preprocessed whole text into a plurality of scene-based semantic chunks;
(e) generating a plurality of summarized texts by summarizing each of the subdivided semantic chunks using a second large language model;
(f) generating a summarized whole text by connecting the plurality of summarized texts;
(g) segmenting the summarized whole text into a plurality of sentence chunks;
(h) generating a plurality of compressed texts by compressing each of the sentence chunks using a third large language model; and
(i) generating a compressed whole text by connecting the plurality of compressed texts.

2. The method according to claim 1, further comprising the step of (j) regenerating the compressed whole text by repeatedly performing steps (g) to (i), when a length of the compressed whole text exceeds a preset token length.

3. The method according to claim 2, wherein the repeated performance of step (j) is limited within a preset number of times.

4. The method according to claim 1, wherein the scene-based semantic chunks are set to include a preset number of scenes.

5. The method according to claim 3, wherein the preset number is dynamically calculated according to the total number of tokens or scenes of the narrative input text.

6. The method according to claim 1, wherein the scene is distinguished by at least one among a time change marker, a location change marker, an event transition marker, and a scene transition marker included in the narrative input text.

7. The method according to claim 1, wherein step (b) further includes the step of (b-1) providing the dialogue and an output instruction configured to convert the dialogue into third-person descriptive sentences to the first large language model.

8. The method according to claim 1, wherein step (e) further includes the step of (e-1) providing the subdivided semantic chunks and an output instruction configured to summarize the subdivided semantic chunks to the second large language model.

9. The method according to claim 1, wherein step (h) further includes the step of (h-1) providing the sentence chunks and an output instruction configured to compress the sentence chunks to a third large language model.

10. The method according to claim 7, wherein the output instruction is configured to request generation of a text containing at least one among a key event, an interaction between characters, and a theme of a narrative.

11. The method according to claim 7, wherein the output instruction is configured to request generation of a text that satisfies a preset token length.

12. The method according to claim 7, wherein the output instruction includes an example pair of text corresponding to input and output.

13. The method according to claim 7, wherein the output instruction is generated by providing at least one among the dialogue, the subdivided semantic chunks, and the sentence chunks to at least one among the first large language model, the second large language model, and the third large language model.

14. The method according to claim 1, wherein the first large language model, the second large language model, and the third large language model share the same model or are configured as models different from each other.

15. The method according to claim 1, wherein the first large language model, the second large language model, and the third large language model are configured without additional training or fine-tuning of model parameters.

16. A narrative text summarization system comprising a central processing unit and a memory, wherein
the central processing unit executes instructions for performing a narrative text summarization method stored in the memory, and
the method includes the steps of:
(a) segmenting a narrative input text containing dialogues and descriptions into a plurality of scene-based semantic chunks;
(b) generating a plurality of preprocessed texts by converting the dialogue contained in each of the semantic chunks into third-person descriptive sentences using a first large language model;
(c) generating a preprocessed whole text by connecting the plurality of preprocessed texts;
(d) subdividing the preprocessed whole text into a plurality of scene-based semantic chunks;
(e) generating a plurality of summarized texts by summarizing each of the subdivided semantic chunks using a second large language model;
(f) generating a summarized whole text by connecting the plurality of summarized texts;
(g) segmenting the summarized whole text into a plurality of sentence chunks;
(h) generating a plurality of compressed texts by compressing each of the sentence chunks using a third large language model; and
(i) generating a compressed whole text by connecting the plurality of compressed texts.

17. The system according to claim 16, wherein the central processing unit is configured to regenerate the compressed whole text by repeatedly performing steps (g) to (i), when a length of the compressed whole text exceeds a preset token length.

18. The system according to claim 17, wherein the repeated performance is configured to be limited within a preset number of times.

19. The system according to claim 16, wherein the central processing unit is configured so that the scene-based semantic chunks are set to include a preset number of scenes.

20. The system according to claim 16, wherein the first large language model, the second large language model, and the third large language model share the same model or are configured as models different from each other.
